(19) United States
(12) Patent Application Publication
(10) Pub. No.: US 2009/0300343 A1
(43) Pub. Date: Dec. 3, 2009

(54) METHOD AND APPARATUS FOR CHANGING BIOS PARAMETERS VIA A HOT KEY

(76) Inventors: Huan Wei LAN, Taipei Hsien (TW); Chia Yi Chang, Taipei Hsien (TW); Kai Ching Chen, Taipei Hsien (TW)

Correspondence Address: Muncy, Geissler, Olds & Lowe, PLLC, P.O. BOX 1364, FAIRFAX, VA, 22038-1364, US

(21) Appl. No.: 12/272,486

(22) Filed: Nov. 17, 2008

(30) Foreign Application Priority Data
Jun. 3, 2008 (TW) 097120554

(51) Int. Cl. G06F 9/00

(52) U.S. Cl. 713/2

(57) ABSTRACT

An apparatus for changing BIOS parameters via a hot key, including a control unit, a microprocessor, a first memory, a second memory, a third memory and a keyboard. The first memory saves BIOS code while the third memory saves N parameter banks of BIOS. When the apparatus performs a keyboard-scanning process during power-on, the apparatus determines whether at least one hot key is triggered. If the hot key is triggered, the apparatus selects one of the N parameter banks. Then the BIOS performs a corresponding operation based on the selected parameter bank. The invention provides a method for changing BIOS parameters via a hot key through the apparatus.

### BACKGROUND OF THE INVENTION

1. Field of the Invention

The present invention relates to a method of computer organization and operations, particularly to a method for changing BIOS parameters via a hot key.

2. Description of the Prior Art

Increasing progress of semiconductor technologies leads to higher performance of electronic components. Nowadays many computer users are enthusiastic about overclocking, which can increase the performance of hardware on their existing hardware with low costs or nothing at all. A lot of inexperienced computer users admire these computer enthusiasts for their competency in performing overclocking, though they hardly dare to overclock their own computers. Consequently, overclocking is something that these computer users love but fear.

Overclocking is a process of boosting the operating frequency (that is, a clock rate; more clock cycles per second) of hardware such as central processing units (CPU) and video cards, such that the overclocked hardware can run stably at a frequency higher than the rated frequency. Taking the Intel P4C 2.4 GHz microprocessor as an example, its rated operating frequency is 2.4 GHz. If its operating frequency is increased to 2.6 GHz, the system may still run stably, thus indicating that it is successfully overclocked. As far as microprocessor overclocking is concerned, its primary object is to increase CPU's operating frequency, which is CPU's internal clock. In addition, the CPU internal clock speed is the product of the front side bus (FSB) speed and the CPU's multiplier factor (sometimes called the clock ratio). For example, if the microprocessor's FSB is 100 MHz and its multiplier factor is 8.5, then the CPU's clock speed=CPU's FSB Speed×CPU's Multiplier Factor=100 MHz×8.5=850 MHz.

Given that the FSB speed is generally highly related to the speed of a front side bus (FSB) and a memory, the performance of the microprocessor, the system and the memory is boosted after boosting the microprocessor's FSB. Currently, overclocking is primary set by the Basic Input Output System (BIOS). Mainstream motherboards change CPU's multiplier factor or FSB speed through the more convenient BIOS settings instead of jumper settings and the switch mode. In other words, users set the microprocessor's multiplier factor and FSB speed in the microprocessor's parameter settings by entering the BIOS's operating interface. If the computer is unable to be restarted normally after overclocking, the computer will automatically resume its default status just by restarting the computer.

For example, when overclocking via BIOS's operating interface, at least the following factors shall be considered:

### 1. CPU Voltage

### 2. CPU FSB Frequency

### 3. CPU Ratio

### 4. DRAM Configuration

### 5. FSB/Memory Ratio

### 6. PCIE Speed Controller

### 7. PCIE Frequency

### 8. DIMM/PCI Frequency

### 9. Spread Spectrum

### 10. Memory Voltage

### 11. VTT FSB Voltage

### 12. NB Voltage

### 13. SB I/O Power

### 14. SB Core Power

The factors are briefly described below:

1. CPU Voltage: Given that a great number of factors are mutually related in the computer system, it is not easy to find optimum voltage settings. Consequently, the microprocessor may be burned if care is not taken.

2. CPU FSB Frequency: After loading the optimized BIOS defaults, this option will automatically detect and display the microprocessor's FSB. Taking Intel Core 2 Duo E6850 processor as an example, the FSB is displayed as “333 MHz” here. FSB adjustment may be done by number keys or special keys such as “Page Up” or “Page Down”.

3. CPU Ratio: This option involves complicated compatibility issues. According to the frequency of various versions of the microprocessor's FSB (including 1333 MHz, 1066 MHz and 800 MHz), the range of multiplier factors differs. For example, if the user's processor is 1333 MHz, then BIOS's multiplier factor may range from 6 to 8.

4. DRAM Configuration: The function of this option is to adjust the delay cycle of various memory parameters. Users should decide the cycle based on the conditions of the memory or the suggested values provided by memory module manufacturer because not all memory modules can run by using the minimum delay cycle.

5. FSB/Memory Ratio: This option decides the relationship between the system's FSB and the memory's operating frequency (that is, memory ratio). If the ratio is set to “Auto”, the clock of memory will determine the frequency of the processor on the basis of this ratio. For example, if a ratio of 1:1.25 is taken by users and the user is using a 1333 MHz processor with DDR2-800 memory, then the clock of DDR2 will be 833 MHz based on the calculation: 1333 MHz/4×1.25×2=833 MHz. Consequently, users should be capable of calculating the clock of memory.

6. PCIE Frequency: The PCI Express bus clock usually has no direct relationship with overclocking; nevertheless, the system's stability under overclocking should be considered.

7. Memory Voltage: Given that the memory is controlled by the northbridge, the voltage of memory should be considered during overclocking for the sake of the stability of the system.

8. VTT FSB Voltage: To ensure that every core device can be operated at a similar operating voltage, the VTT FSB Voltage should be considered. Consequently, the standards for a northbridge chipset on the motherboard as well as the clock generator should be considered.

9. Spread Spectrum: The “Spread Spectrum” is disabled before overclocking, because this will affect the overclocking limit.

10. NB Voltage: Given that it is important to maintain the stability of the processor, the memory and the graphic card, the power source of a northbridge chipset should be considered.

11. SB I/O Power: The power source of a southbridge chipset should be considered, given that the stability between a northbridge chipset and a southbridge chipset should be maintained.

12. SB Core Power: The core power of a southbridge chipset should be considered, given that the stability between a northbridge chipset and a southbridge chipset should be maintained.

In addition, software overclocking is also a common type of overclocking. For example, SoftFSB is a type of more commonly used software that can support a great number of clock generators. Just by clicking on the “clock generator model number” located on a motherboard and clicking on “GET FSB” for the rights of the clock generator, overclocking may be set by a frequency bar. As soon as the user has made the setting and clicked on “SAVE”, the CPU may run based on the new frequency. Nevertheless, the drawback of software overclocking is that the computer or the system will crash when the CPU is unable to support the user-defined frequency.

According to the aforementioned, before overclocking a system, the user should be able to determine whether the components and the peripherals are sufficient to tolerate or support various overclocking parameter settings. The conventional art for overclocking has at least the following drawbacks:

1. Improper overclocking may lead to system damages and danger.
2. As far as the conventional art of BIOS overclocking is concerned, users must enter the BIOS interface, which is most dreaded by those unfamiliar with computer operations, thus causing them fear and worry. In addition, users dare not try overclocking due to this.
3. The common English BIOS interface and the English technical terms for various parameters make those unfamiliar with computer operations and those with unsatisfactory English competency dare not accept the BIOS interface.
4. As far as the conventional art for BIOS overclocking is concerned, at least 14 parameters must be set by the user as soon as the user enters the BIOS interface. These 14 parameters involve highly professional fields such as electronics, circuits, computer organization, signals and systems and so on. Those not skilled in the art may thus easily cause system damages if overclocking is performed just by guesswork. In addition, it is neither reasonable nor feasible for those unfamiliar with computer operations to overclock a system by setting at least 14 parameters on their own. Hence it is a far-fetched dream for these inexperienced computer users to enjoy the fun of overclocking.
5. The product life cycle of computer systems becomes very short. Given that the standards for new components (such as CPU and DRAM) and hardware are continuously updated and the standards are not uniform, the compatibility of components and hardware need to be considered, which is not convenient at all and easily causes troubles to users.
6. The conventional art for BIOS overclocking and software overclocking lacks a platform for technological exchange. Users, regardless of familiarity with computer operations, are unable to effectively convey their trial-and-error results to the other users, thus wasting resources. Although a great number of forums are available for technological exchange, those unfamiliar with computer operations may not easily and quickly get assistance from these forums due to the insufficiency in their technical background.
7. The conventional art for BIOS overclocking enables users to perform overclocking on the BIOS interface. Nevertheless, users need to be responsible for the failure of overclocking. In addition, it is unfair for technical service providers to provide no assistance to users at all. No platform for technological exchange or troubleshooting diagnosis is available in the conventional art for BIOS overclocking. After a series of trials and errors, the key aspects of errors are unable to be returned as feedback to technical service providers, which leads to the wastage of resources and impedes the progress of the industry.

### SUMMARY OF THE INVENTION

In view of this, the primary object of the present invention is to provide a method for changing BIOS parameters via a hot key and the electronic apparatus thereof. When the electronic apparatus performs a keyboard-scanning process during power-on, the electronic apparatus, without entering the BIOS interface, determines whether at least one hot key is triggered before overclocking is performed. In other words, BIOS parameters can be changed just via a hot key before performing corresponding actions.

To achieve the aforementioned objects, the present invention provides a method for changing BIOS parameters via a hot key, including at least a microprocessor, a first memory, a second memory and a third memory. The first memory saves BIOS code while the second memory saves BIOS parameters. The third memory saves N parameter banks of BIOS. Under specific conditions, the method includes the step of writing a BIOS parameter bank in the second memory. The method includes the steps of saving at least a parameter bank in a third memory and performing a keyboard-scanning process during power-on to determine whether at least one hot key is triggered. If the hot key is triggered, one of N parameter banks is selected. Then the BIOS will perform corresponding operations based on the selected parameter bank during the next power-on. In addition, the present invention provides an electronic apparatus for changing BIOS parameters via a hot key for use in computer systems, including a control unit, a microprocessor, a first memory, a second memory, a third memory and a keyboard. The control unit is electrically coupled to the microprocessor, the first memory, the second memory, the third memory and the keyboard. The first memory saves the BIOS code while the third memory saves N BIOS parameter banks. When the electronic apparatus performs a keyboard-scanning process during power-on, the electronic apparatus determines whether at least one hot key is triggered. If the hot key is triggered, the electronic apparatus selects one of the N parameter banks. Then the BIOS performs a corresponding operation based on the selected parameter bank.

According to a more preferred embodiment of the present invention, the method further includes the steps of: (1) performing the above keyboard-scanning process after the electronic apparatus has been powered on and initiated the keyboard; (2) selecting one of N parameter banks based on various conditions and saving the selected parameter bank in the second memory if this method includes the step of saving a plurality of parameter banks in the third memory; and (3) the BIOS reads the corresponding parameter bank in the second memory and performs a corresponding action during the next power-on.

According to another preferred embodiment of the present invention, the electronic apparatus will automatically select one parameter bank after the hot key is triggered without additional operations from the user. The BIOS when powered on can automatically increase the clock of the microprocessor in the electronic apparatus through the selected parameter bank and automatically change the CPU/DRAM ratio before overclocking the electronic apparatus.

According to another preferred embodiment of the present invention, the method further includes the steps of:

(1) Setting a HOT KEY FLAG as a first value;
(2) Determining whether the hot key is triggered;
(3) Setting the HOT KEY FLAG as a second value if the hot key is triggered;
(4) Setting a second FAIL FLAG as a first value; and
(5) Setting the second FAIL FLAG as a first value if the hot key has not been triggered.

According to another preferred embodiment of the present invention, the method further includes the steps of:

(1) Determining whether a testing process is performed in order to test whether the corresponding parameter bank can be successfully overclocked;
(2) Setting a clock of the microprocessor if the testing process is not performed;
(3) Determining whether a first FAIL FLAG is equal to a second value if the testing process is performed;
(4) Setting the second FAIL FLAG as the second value if the first FAIL FLAG is equal to the second value;
(5) Setting the clock of the microprocessor as a default clock;
(6) Setting the first FAIL FLAG as a first value; and
(7) Determining if the HOT KEY FLAG is equal to the second value.

According to another preferred embodiment of the present invention, the method further includes the steps of:

(1) Determining if a testing process is performed;
(2) Determining whether a first FAIL FLAG is equal to a second value if the testing process is performed;
(3) Setting the first FAIL FLAG as the second value if the first FAIL FLAG is not equal to the second value;
(4) Enabling a watchdog process to detect the system;
(5) Setting a clock of the microprocessor;
(6) Detecting if the electronic apparatus crashes;
(7) Restarting the electronic apparatus if the electronic apparatus crashes;
(8) Setting the first FAIL FLAG as the first value if the electronic apparatus does not crash; and
(9) Determining if the HOT KEY FLAG is equal to the second value.

According to another preferred embodiment of the present invention, the method further includes the steps of:

(1) Determining whether a HOT KEY FLAG is equal to a second value;
(2) Testing the FSB of the microprocessor if the HOT KEY FLAG is equal to the second value;
(3) Setting the corresponding parameter bank based on the FSB of the microprocessor;
(4) Detecting DRAM speed;

### (5) Generating the CPU/DRAM Ratio;

(6) Writing the corresponding parameter bank in the second memory; and
(7) Restarting the electronic apparatus.

According to another preferred embodiment of the present invention, the method further includes the steps of:

(1) Determining if a HOT KEY FLAG is equal to a second value;
(2) Determining whether a FAIL RELOAD process is performed if the HOT KEY FLAG is not equal to the second value;
(3) Determining whether an AUTO UPGRADE process is performed if the HOT KEY FLAG is equal to the second value;
(4) Setting a single-mode parameter;
(5) Enabling a testing process;
(6) Setting a reload counter;
(7) Determining whether the FAIL RELOAD process is performed;
(8) Determining whether a second FAIL FLAG is equal to a second value if the FAIL RELOAD process is performed;
(9) Determining whether a single-mode process is performed if the second FAIL FLAG is equal to the second value;
(10) Selecting a parameter bank and writing the corresponding parameter bank in the second memory if the single-mode process is performed;
(11) Restarting the electronic apparatus;
(12) Continuing with Step (7), setting the reload counter as a fourth value if the FAIL RELOAD process is not performed or if the second FAIL FLAG is not equal to the second value;
(13) Determining if the second FAIL FLAG is equal to the second value;
(14) Displaying a message “Overclocking Failed” on the screen if the second FAIL FLAG is equal to the second value;
(15) Ending the process if the second FAIL FLAG is not equal to the second value;
(16) Continuing with Step (9), determining whether the reload counter is equal to the fourth value if the single-mode process is not performed;
(17) Setting the reload counter as a third value if the reload counter is equal to the fourth value;
(18) Writing the corresponding parameter bank in the second memory based on contents of the reload counter;
(19) Restarting the electronic apparatus;
(20) Continuing with Step (16);
(21) Subtracting 1 from the load counter if the reload counter is not equal to the fourth value;
(22) Writing the corresponding parameter bank in the second memory based on contents of the reload counter; and
(23) Restarting the electronic apparatus.

According to another preferred embodiment of the present invention, the method further includes the step of forming an exchange file through N parameter banks. The exchange file includes N parameter banks and control parameters in the second memory.

According to another preferred embodiment of the present invention, the method further includes an operating interface process, which further includes the steps of:

(1) Forming, writing, reading, modifying and opening the exchange file;
(2) Selecting one of N parameter banks;
(3) Performing a corresponding BIOS action based on the selected parameter bank during the next power-on;
(4) Writing the exchange file in the third memory;
(5) Saving contents of the third memory in the exchange file; and
(6) Writing the selected parameter bank in the second memory.

In view of the above, the present invention provides a method and an electronic apparatus for changing BIOS parameters via a hot key with at least the following advantages:

1. As far as users unfamiliar with computer operations are concerned, operating the BIOS interface scares users and makes them hang back at the sight of the complicated BIOS interface and a great number of parameters that are not understandable to them. Under such conditions, it is a farfetched dream for users to overclock hardware successfully. However, by clicking on a button during power-on to directly and quickly overclock a computer without the need to enter the BIOS interface, the present invention has completely overcome the drawbacks of the conventional art. Consequently, the present invention is really good to those who are unfamiliar with computer operations.

2. After the user has enjoyed the fun of successful overclocking, the present invention allows users to make trials and errors. In other words, four parameter banks are written in the second memory (CMOS) in a loop in an attempt to find an optimum parameter bank and effectively enhance the compatibility of the present invention. The present invention has carefully considered users' needs and is thus very personalized.

3. Due to the popularity of the Internet, an exchange file can be sent to remote service providers quickly and easily via the Internet. Given that the operating interface process has recorded the parameters of the second memory in the exchange file, the remote service providers can diagnose users' computers. For example, when inexperienced computer users fail to overclock hardware, the remote service providers carefully diagnose users' computers, modify exchange files and return the modified exchange files to users. In this way, users can easily enjoy the fun of overclocking. This is obvious that the exchange file designed by the present invention has potentially high benefits.

4. According to 3 set out above, remote service providers can assist users' computer diagnosis. This implies that a new service can be offered through the method. Through the present invention, remote service providers can gain profits from the new service, allow users to live more conveniently and foster mutual benefits between service providers and consumers. Furthermore, this business model allows remote service providers to develop a better understanding of users' needs, improve products and effectively promote industry upgrading. The present invention thus has potentially high benefits.

5. According to 3 set out above, various forums for technological exchange provide users with self-learning opportunities as a result of the popularity of the Internet. Technological exchange can be made among users through the exchange file, thereby lowering the consumption of time and resources. Consequently, the present invention provides opportunities for promoting technological exchange, lowering the consumption of time and resources and making living more convenient.

6. The present invention further provides an operating interface which is capable of forming, writing, reading, modifying and opening an exchange file, such that inexperienced computer users can easily process the exchange file. Consequently, the present invention offers all-in-one services to those unfamiliar with computer operations and assists them in overcoming technical barriers and optimizing their computer performance.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein.

FIG. 1 shows an electronic apparatus for changing BIOS parameters via a hot key made according to a more preferred embodiment of the present invention;

FIG. 2 is a flowchart illustrating a method for changing BIOS parameters via a hot key made according to a more preferred embodiment of the present invention;

FIGS. 3˜6 are flowcharts illustrating a method for changing BIOS parameters via a hot key made according to a more preferred embodiment of the present invention;

FIGS. 7A˜7B are flowcharts illustrating a method for an operating interface process made according to a more preferred embodiment of the present invention;

FIG. 8 is a schematic view illustrating a mode-query screen made according to a more preferred embodiment of the present invention;

FIG. 9 is a schematic view illustrating a main screen made according to a more preferred embodiment of the present invention;

FIG. 10 is a flowchart illustrating a method for an operating interface process made according to a more preferred embodiment of the present invention;

FIG. 11 is a flowchart illustrating a method for an operating interface process made according to a more preferred embodiment of the present invention;

FIG. 12 is a schematic view illustrating a RELOAD screen made according to a more preferred embodiment of the present invention;

FIG. 13 is a schematic view illustrating an AUTO UPGRADE screen made according to a more preferred embodiment of the present invention;

FIG. 14 is a flowchart illustrating a first BACKUP process made according to a more preferred embodiment of the present invention;

FIG. 15 is a schematic view illustrating a RELOAD BACKUP screen made according to a more preferred embodiment of the present invention;

FIG. 16 is a flowchart illustrating a first RELOAD process made according to a more preferred embodiment of the present invention;

FIG. 17 is a schematic view illustrating a RELOAD READ screen made according to a more preferred embodiment of the present invention;

FIG. 18 is a flowchart illustrating a first RELOAD process made according to a more preferred embodiment of the present invention;

FIG. 19 is a flowchart illustrating a second BACKUP process made according to a more preferred embodiment of the present invention;

FIG. 20 is a schematic view illustrating an UPGRADE BACKUP screen made according to a more preferred embodiment of the present invention;

FIG. 21 is a flowchart illustrating a second RELOAD process made according to a more preferred embodiment of the present invention;

FIG. 22 is a schematic view illustrating an UPGRADE RELOAD screen made according to a more preferred embodiment of the present invention; and

FIG. 23 is a flowchart illustrating a second RELOAD process made according to a more preferred embodiment of the present invention.

### DETAILED DESCRIPTION OF THE PREFERRED EMBODIMENTS

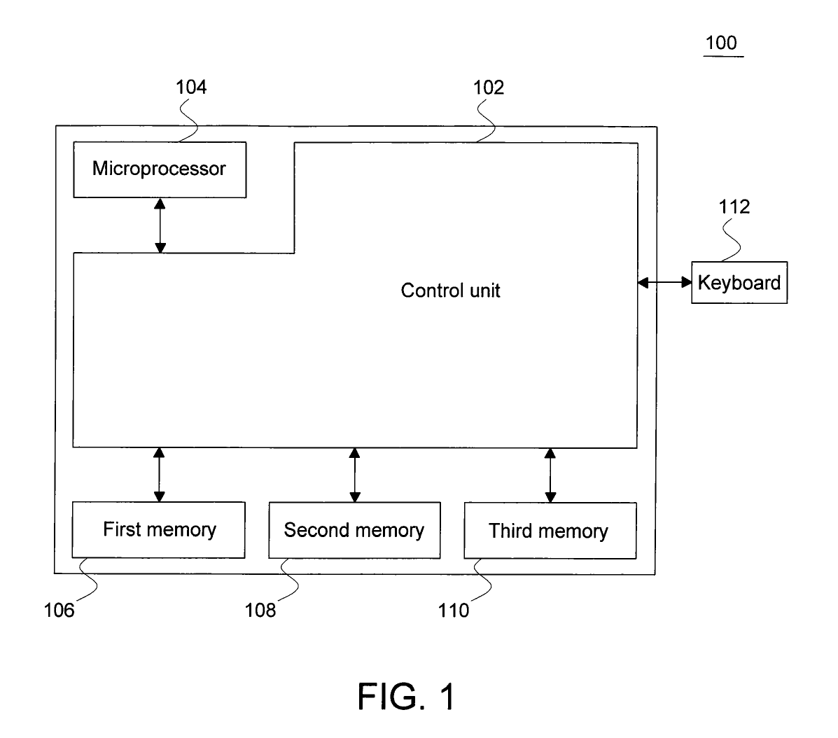

Referring to FIG. 1, it is an electronic apparatus for changing BIOS parameters via a hot key made according to a more preferred embodiment of the present invention. The electronic apparatus 100 for changing BIOS parameters via a hot key includes a control unit 102, a microprocessor 104, a first memory 106, a second memory 108, a third memory 110 and a keyboard 112. The control unit 102 is electrically coupled to the microprocessor 104, the first memory 106, the second memory 108, the third memory 110 and the keyboard 112.

The first memory 106 saves a BIOS code. When the electronic apparatus 100 performs a keyboard-scanning process during power-on, the electronic apparatus 100 determines whether a hot key is triggered. If the hot key is triggered, the electronic apparatus 100 or a user selects one of the N parameter banks as the BIOS parameter during the next power-on. Consequently, the BIOS performs a corresponding operation (for example, overclocking) based on the selected parameter bank. After the electronic apparatus 100 is started and initiates the keyboard 112, the electronic apparatus 100 performs the keyboard-scanning process. If the third memory 110 saves a plurality of parameter banks, the user can select one of these parameter banks and save the selected parameter bank in the second memory 108.

During the next power-on, the BIOS reads the corresponding parameter bank in the second memory 108 to perform a corresponding action. If the corresponding action is overclocking and if the hot key is triggered, the electronic apparatus 100 automatically selects one of these parameter banks. Through the selected parameter bank, the BIOS can automatically boost a clock of the microprocessor 104. In other words, the electronic apparatus can be overclocked without the need to enter the BIOS interface.

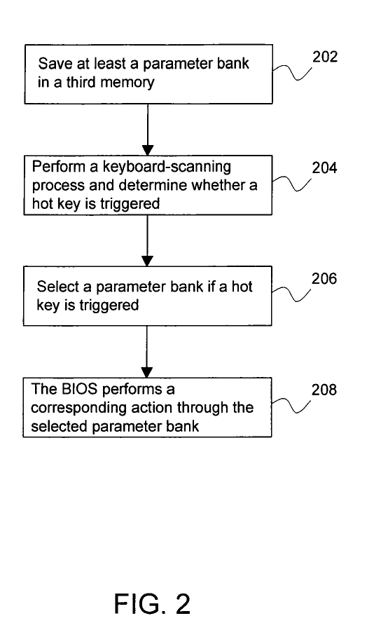

Referring to FIG. 2, it is a flowchart illustrating a method for changing BIOS parameters via a hot key made according to a more preferred embodiment of the present invention. The present method is suitable for electronic apparatuses. The electronic apparatus in the present method includes at least a first memory, which saves BIOS code. The method includes the steps of saving at least a parameter bank in the third memory (S202), performing a keyboard-scanning process and determining whether at least a hot key is triggered (S204), selecting a parameter bank if the hot key is triggered (S206) and performing a corresponding BIOS action based on the selected parameter bank (S208).

When the electronic apparatus is started and initiates the keyboard, the keyboard-scanning process is performed. If a plurality of parameter banks is saved, one of these parameter banks is selected and saved in the second memory. During the next power-on, the BIOS reads the corresponding parameter bank in the second memory so as to perform a corresponding action. If the hot key is triggered, the electronic apparatus automatically selects a parameter bank. Based on the selected parameter bank, the BIOS automatically boosts the clock of the microprocessor in the electronic apparatus. If the hot key is triggered, the electronic apparatus automatically selects a parameter bank. Based on the parameter bank, the BIOS automatically changes the CPU/DRAM ratio. A testing process is performed to test whether the BIOS can successfully perform a corresponding action based on the selected parameter bank.

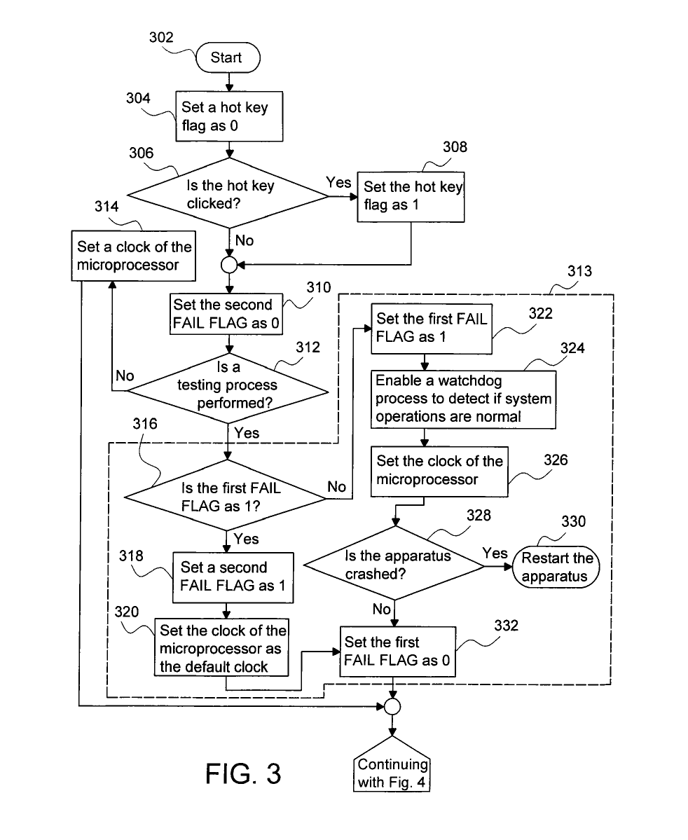

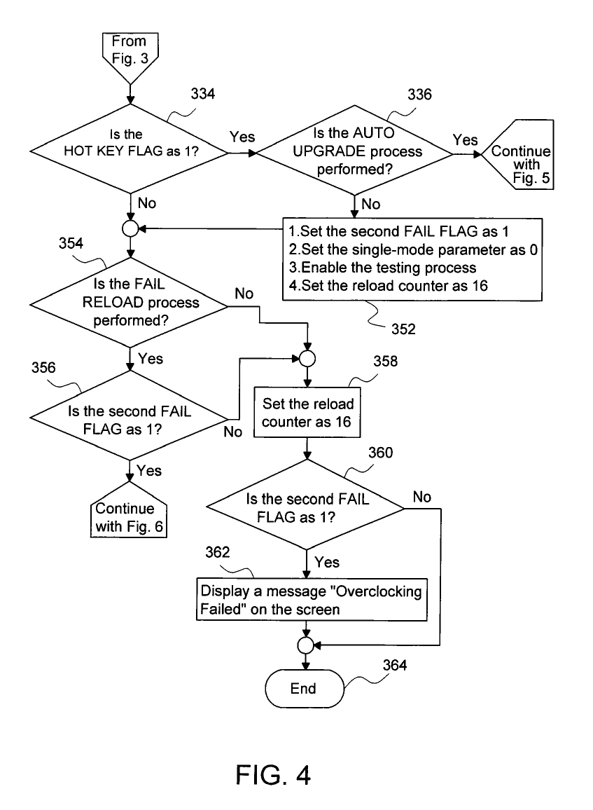

Referring to FIGS. 3˜6, they are flowcharts each illustrating a method for changing BIOS parameters via a hot key made according to a more preferred embodiment of the present invention. According to the present embodiment, the first value is 0; the second value is 1; the third value is 4; and the fourth value is 16. Four parameter banks are pre-saved in the third memory. The method includes the steps of setting a HOT KEY FLAG as 0 (S304), determining if the hot key is triggered (S306); setting the HOT KEY FLAG as 1 if the hot key is triggered (S308), setting the second FAIL FLAG as 0 (S310), setting the second FAIL FLAG as 0 if the hot key is not triggered (S310), determining if the testing process is performed (S312), and setting a clock of the microprocessor if the testing process is not performed (S314). The clock of the microprocessor can be set via a conventional BIOS interface. S314 is the step for setting a clock generator of the microprocessor. Then the step (S334) described in FIG. 4 is then performed.

If a testing process is performed (S313), the method determines whether the first FAIL FLAG is 1 (S316). If the first FAIL FLAG is 1, the method sets a second FAIL FLAG as 1 (S318). Then the clock of the microprocessor is set as the default clock (S320). If the first FAIL FLAG is not 1, the first FAIL FLAG is set as 1 (S322). The method subsequently enables a watchdog process to detect if system operations are normal (S324). In addition, the method sets the clock of the microprocessor (S326) and determines if the electronic apparatus crashes (S328). If the electronic apparatus crashes, the electronic apparatus is restarted (S330). However, if the electronic apparatus does not crash, the method sets the first FAIL FLAG as 0 (S332).

Referring to FIG. 4, the method includes the steps of determining whether the HOT KEY FLAG is 1 (S334), determining whether an AUTO UPGRADE process is performed if the HOT KEY FLAG is 1, and automatically boosting the clock of the microprocessor (S336). Referring to FIG. 5, if the AUTO UPGRADE process is performed, the method includes the step of setting the corresponding parameter bank based on the microprocessor's FSB in order to perform a corresponding BIOS action. The AUTO UPGRADE process includes the steps of testing whether the microprocessor's FSB is 800 MHz (S338), reloading a first parameter bank if the microprocessor's FSB is 800 MHz (S340), detecting DRAM speed (S342), generating a new CPU/DRAM ratio (S344), displaying a message and indicating that the corresponding parameter bank is to be written in the second memory (S346), writing the corresponding parameter bank in the second memory (S348) and restarting the electronic apparatus (S350). When the microprocessor's FSB is 1066 MHz or 1333 MHz, the steps of the present method are similar to those when the microprocessor's FSB is 800 MHz.

Referring to FIG. 4 again, continuing with S336, if the HOT KEY FLAG is 1 and the AUTO UPGRADE process is not performed, then the method includes the steps of (1) setting the second FAIL FLAG as 1; (2) setting the single-mode parameter as 0; (3) enabling the testing process; and (4) setting the reload counter as 16 (S352). In this embodiment, the user can choose if the testing process is performed. However, if the user does not perform the AUTO UPGRADE process, the method tests whether the four parameter banks can successfully be overclocked in a loop by means of trial and error. Consequently, if the user does not perform the AUTO UPGRADE process, then the testing process must be performed.

Referring to FIG. 4 again, continuing with S334, if the HOT KEY FLAG is not 1, then the method includes the steps of determining whether the FAIL RELOAD process is performed (S354), setting the reload counter as 16 (S358) if the FAIL RELOAD process is not performed or if the second FAIL FLAG is determined not to be 1 (S356), determining whether the second FAIL FLAG is 1 (S360), displaying a message “Overclocking Failed” on the screen if the second FAIL FLAG is 1 (S362), ending the process if the second FAIL FLAG is not 1 (S364), and continuing with S354, determining whether the second FAIL FLAG is 1 (S356). Referring to FIG. 6, the method includes the steps of determining whether the single-mode process is performed (S366), and selecting a parameter bank and writing the corresponding parameter bank in the second memory if the single-mode process is performed. In the present embodiment, the method includes the steps of determining whether a first parameter bank is selected (S368), reloading the first parameter bank if the method performs the step of choosing a first parameter bank (S370), displaying a message and indicating that the corresponding parameter bank is to be written in the second memory (S372), writing the corresponding parameter bank in the second memory (S374) and restarting the electronic apparatus (376). The second parameter bank, the third parameter bank and the fourth parameter bank are processed in a similar manner as the first parameter bank.

Referring to FIG. 6 again, continuing with S366, if the method does not perform the single mode, then the method includes the steps of determining whether the reload counter is 16 (S378), subtracting 1 from the load counter if the reload counter is not 16 (S380), setting the reload counter as 4 if the reload counter is 16 (S382), displaying a message and indicating that the corresponding parameter bank is to be written in the second memory (S384), writing the corresponding parameter bank in the second memory based on the reload counter (S386), and restarting the electronic apparatus (S376). What is worth mentioning is that the method tests whether the four parameter banks can be successfully overclocked in a loop by means of trial and error. Consequently, when the reload counter is 16, it means that no trial and error is made. The method sets the reload counter as 4 (meaning four parameter banks) for trial and error. It should be noted that FIGS. 3˜6 can perform actions described as below:

1. The method is capable of auto upgrading the electronic apparatus (skipping one step for automatic overclocking);
2. The method is capable of assigning a parameter bank as a BIOS parameter;
3. The method is capable of finding a BIOS parameter by means of trial and error and assigning a parameter bank as a starting point for trial and error.

The method performs the step of forming an exchange file from the plurality of parameter banks as well as parameters and control parameters in the second memory. Given that the exchange file saves the parameters in the second memory, the exchange file can be provided to remote service providers for diagnosing users' electronic devices. The method can decide whether the AUTO UPGRADE process is performed based on the control parameters. In addition, the method can also select a parameter bank based on the control parameters. The purpose of the exchange file is to allow the remote service provider and the near-end user to transmit the exchange file via the Internet, allow the user to change the corresponding BIOS parameter in a real-time manner for overclocking, and interactively transmit the exchange file among users for interaction and exchange.

The method provides an operating interface process, which includes the steps of:

(1) Forming, writing, reading, modifying and opening the exchange file;
(2) Selecting one of N parameter banks through the operating interface process;
(3) Performing a corresponding BIOS action based on the selected parameter bank during the next power-on;
(4) Writing the exchange file in the third memory;
(5) Saving contents of the third memory in the exchange file; and
(6) Modifying data in the second memory.

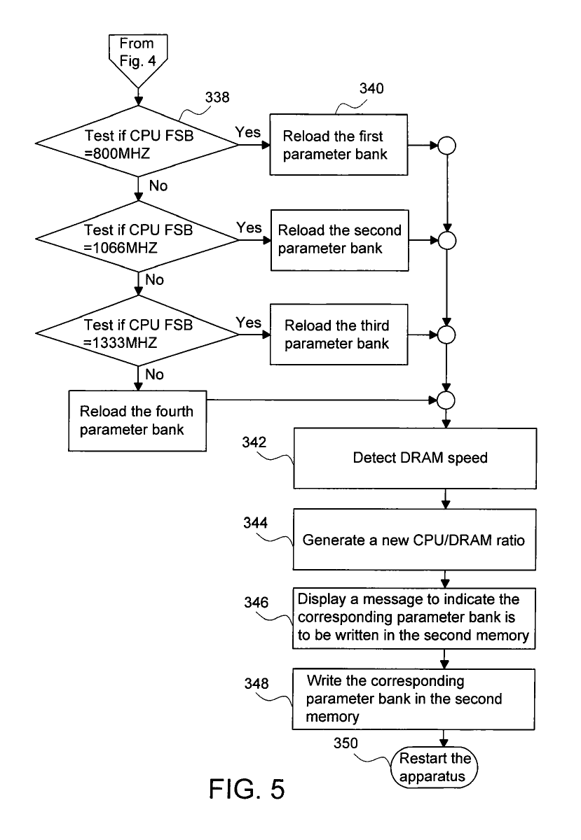

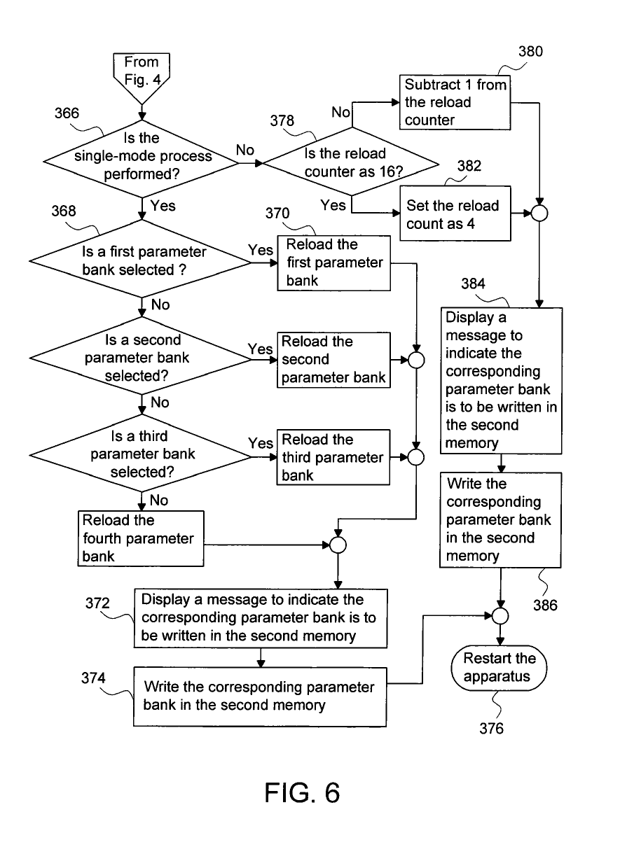

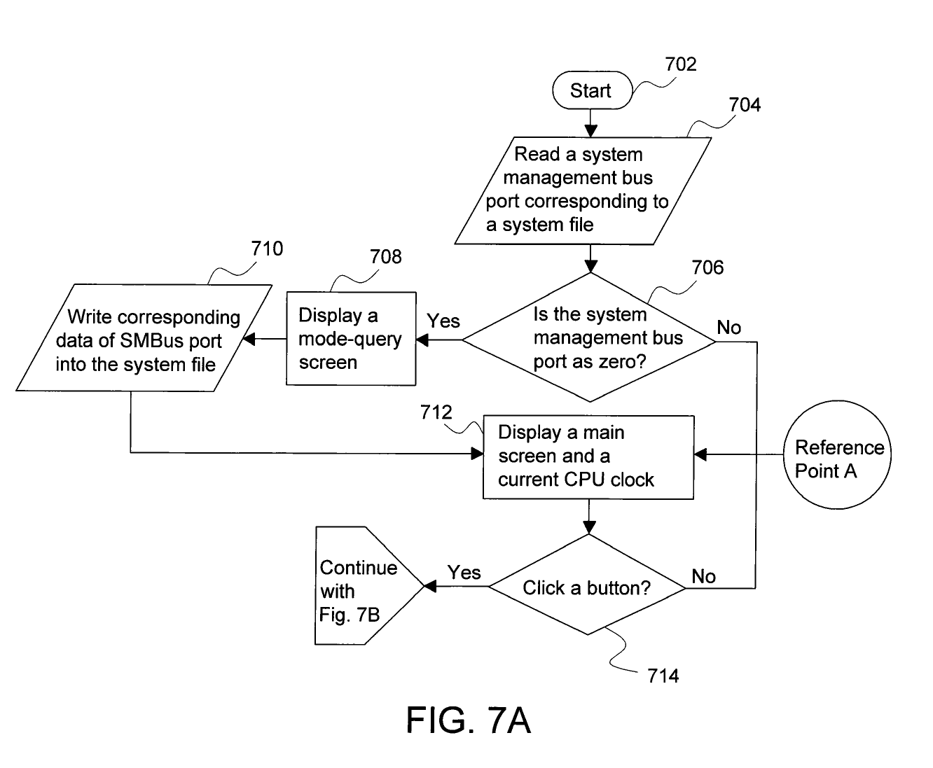

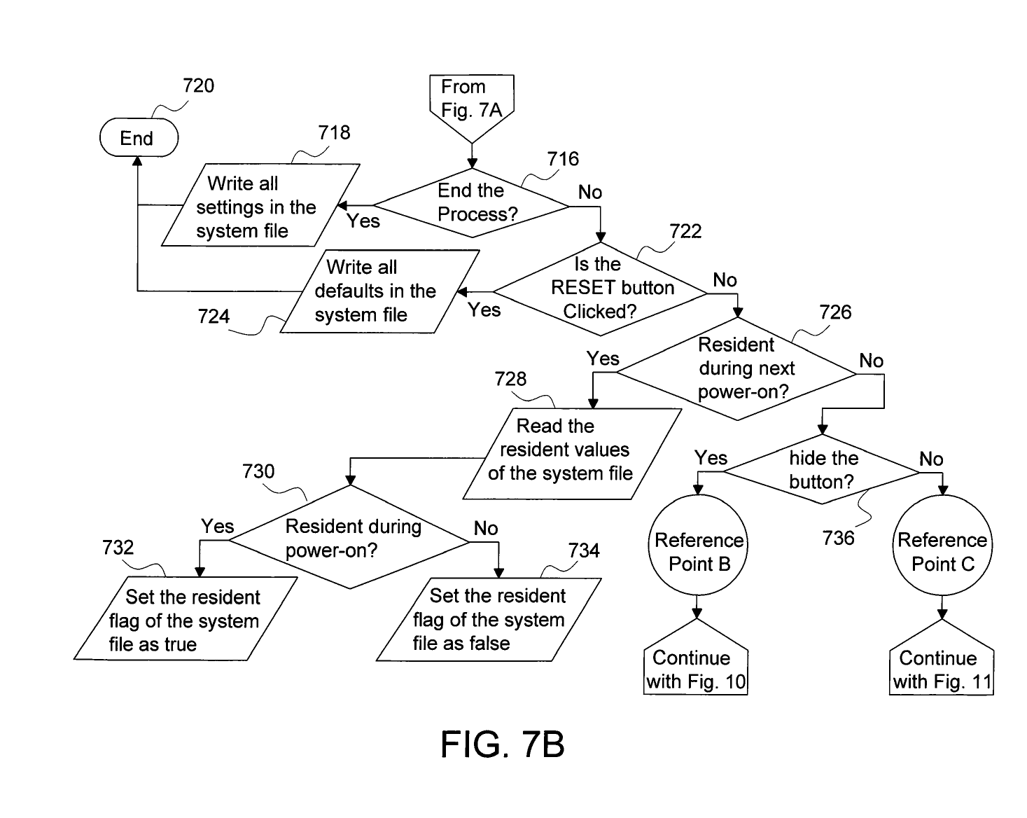

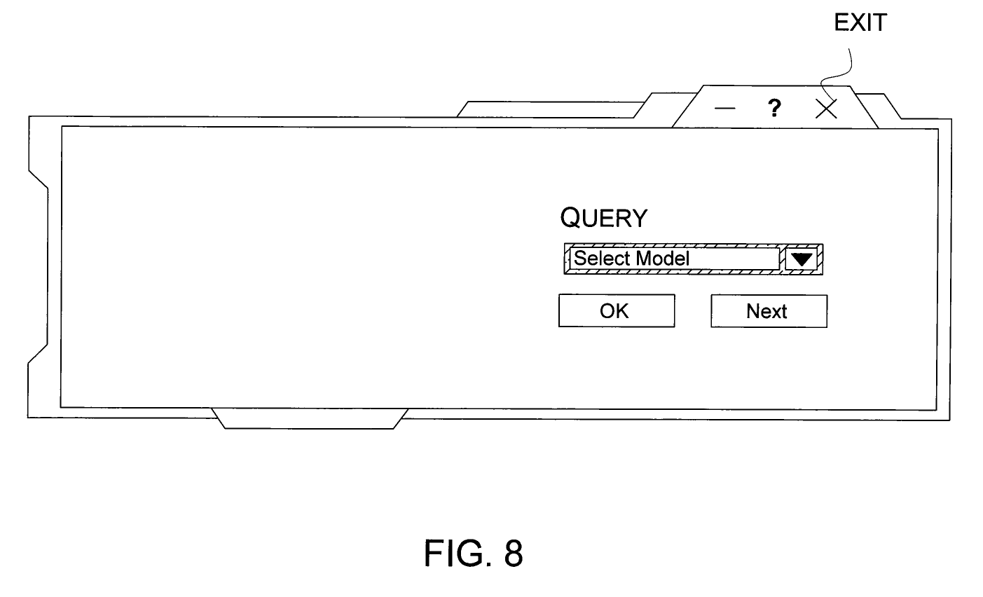

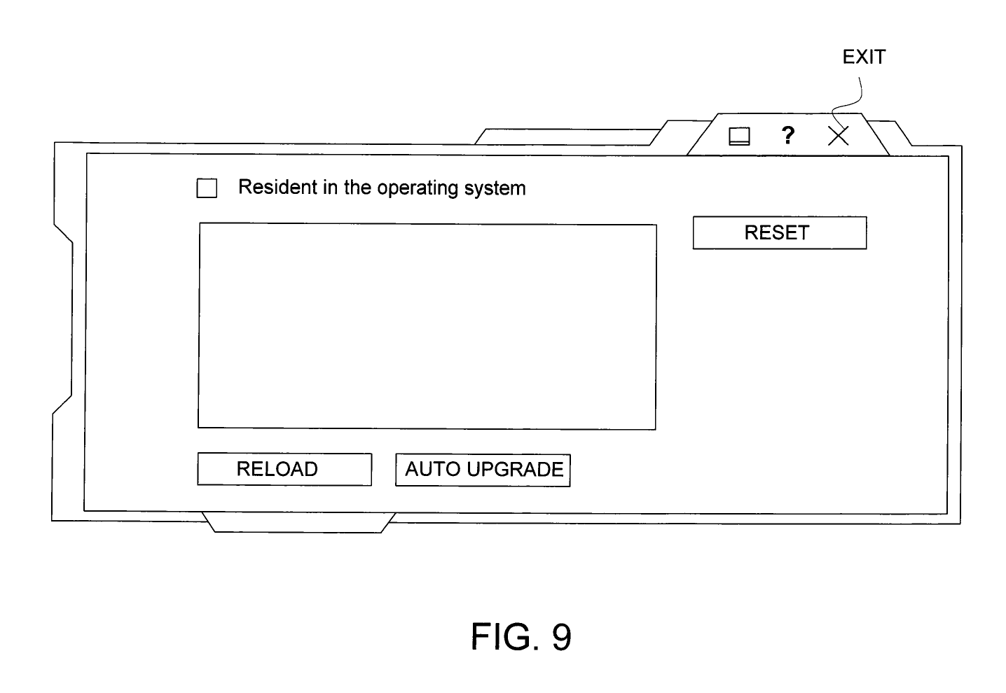

Referring to FIGS. 7A˜7B, they are flowcharts illustrating a method for an operating interface process made according to a more preferred embodiment of the present invention. The operating interface process includes the steps of: reading a system management bus (SMBus) port of a system file (S704), determining whether the system management bus port is zero (S706), displaying a mode-query screen on the screen if the system management bus port is zero (S708), recording data on the system management bus port in the system file (S710), displaying a main screen, which displays a real-time clock of the microprocessor (S712), and determining whether a button is clicked (S714). Referring to FIG. 8, it is a schematic view illustrating a mode-query screen made according to a more preferred embodiment of the present invention. Referring to FIG. 9, it is a schematic view illustrating a main screen made according to a more preferred embodiment of the present invention.

Referring to FIG. 7B, continuing with S714, the method includes the steps of determining whether the operating interface process is to be ended (S716), writing all the settings in the system file if the operating interface process is ended (S718), ending the operating interface process (S720), determining whether the corresponding RESET button is clicked if the operating interface process is not ended (S722), writing all the default values in the system file if the corresponding RESET button is clicked (S724) and determining whether the operating interface process must be resident during the next power-on if the corresponding RESET button is not clicked. According to the present embodiment, the method includes the step of determining whether the “Resident in the Operating System” on the screen (S726) is selected. If the operating interface process is resident, the method includes the step of displaying a target icon on the task bar. When the user's mouse comes into contact with the target icon, the target icon indicates the clock of the corresponding component in the electronic apparatus.

Referring to FIG. 7B again, continuing with S726, the method includes the step of reading a resident value if the operating interface process is resident during the next power-on (S728), determining whether a resident function is enabled (S730), setting a resistant flag of the system file as true if the resident function is enabled (S732), and setting a resident flag of the system file as false if the resident function is not enabled (S734).

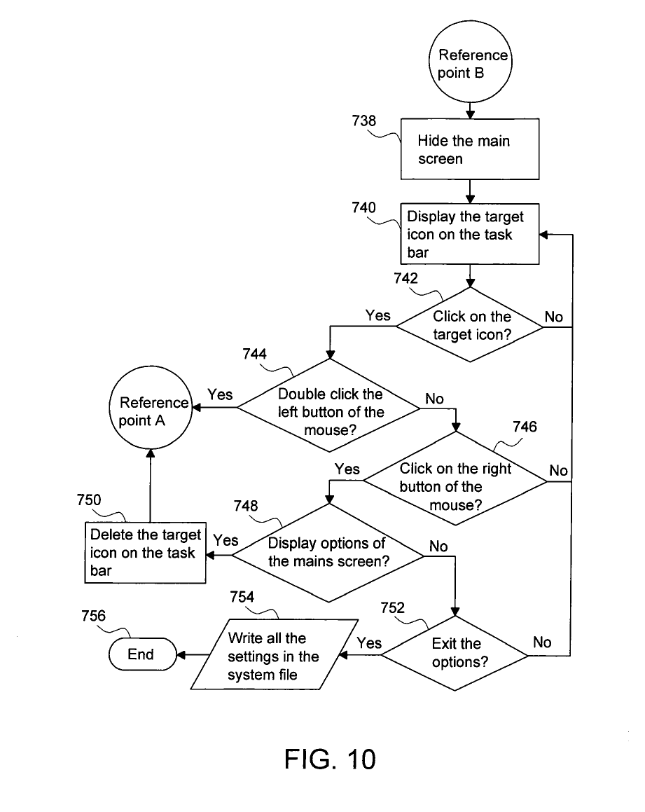

Referring to FIG. 10, continuing with S726, the method includes the steps of determining whether a button is hidden if the user decides that the system is not resident during the next power-on (S736). If the user chooses the HIDE button, the method performs the step of hiding the main screen as indicated in FIG. 10 (S738). Then the method performs the step of displaying a target icon (not shown on the drawing) on the task bar (S740), determining whether the target icon is clicked (S742), determining whether a left button of a mouse is double clicked (S744), displaying the main screen (skipping to Reference Point A) if the left button of the mouse is double clicked, determining whether a right button of the mouse is clicked if the left button of the mouse is not double clicked (S746), determining whether options of the main screen are displayed if the right button of the mouse is clicked (S748), deleting the target icon on the task bar if the options of the main screen are displayed (S750), determining whether the user chooses to exit if the options of the main screen are not displayed (S752), writing all the settings in a system file if the user selects to exit (S754) and ending the operating interface process (S756).

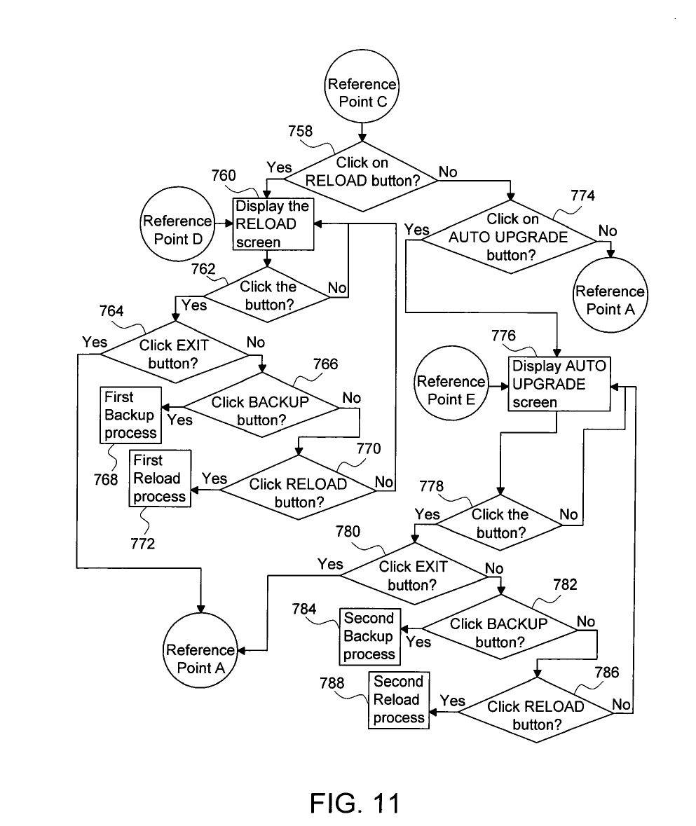

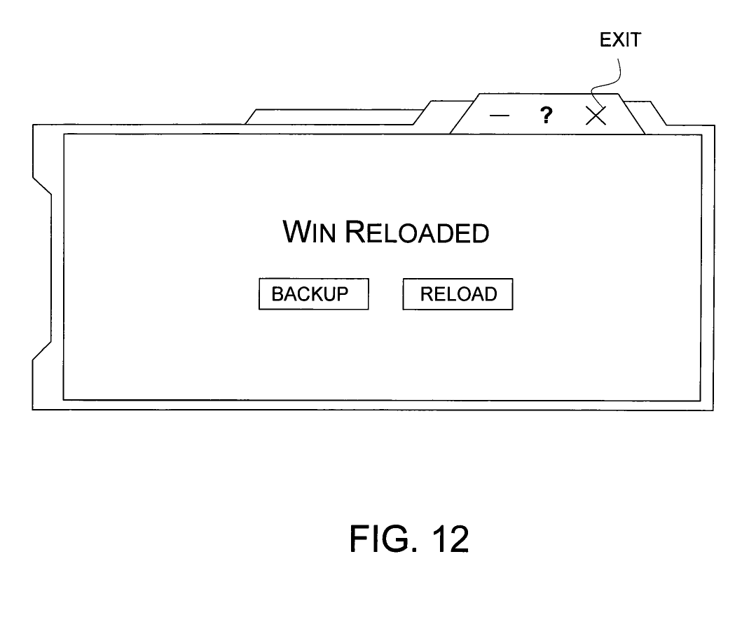

Referring to FIG. 11, continuing with S736, the method includes the steps of clicking on a RELOAD button on the main screen if the HIDE button (S758) is not selected, displaying a RELOAD screen if the RELOAD button is clicked (S760), determining whether the button is clicked (S762), determining whether the EXIT button (S764) is clicked, skipping to the Reference Point A if the EXIT button is clicked, determining whether the corresponding BACKUP button is clicked if the EXIT button is not clicked (S766), performing the first BACKUP process, checking a saving format and saving contents of the third memory in the exchange file if the corresponding BACKUP button is clicked (S768), and determining whether the corresponding RELOAD button is clicked if the BACKUP button is not clicked (S770), performing a first RELOAD process, and checking an opening format and saving contents of the exchange file in the third memory if the corresponding RELOAD button is clicked (S772). Referring to FIG. 12, it is a schematic view illustrating a RELOAD screen made according to a more preferred embodiment of the present invention.

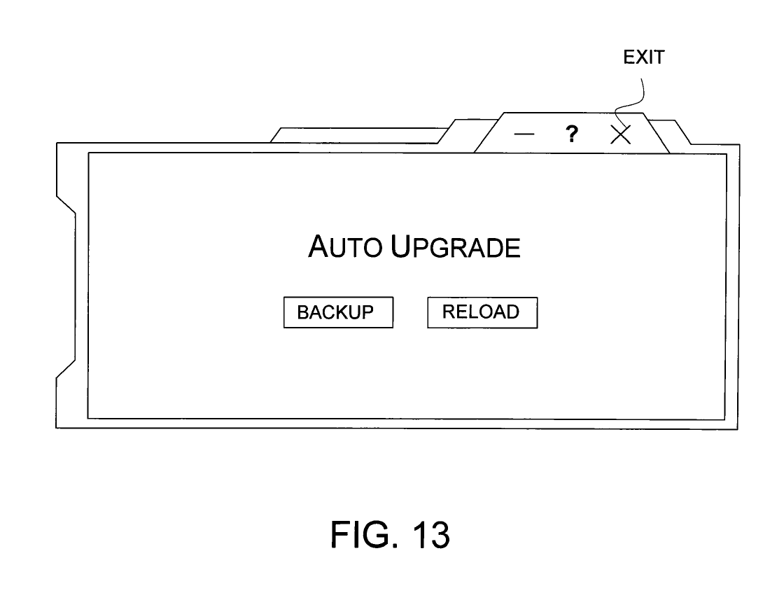

Referring to FIG. 11 again, continuing with S758, the method includes the step of determining whether the AUTO UPGRADE button of the main screen is clicked if the RELOAD button is not clicked (S774). The method displays an AUTO UPGRADE screen if the AUTO UPGRADE button on the main screen is not clicked (S776). Then the method determines whether the button is clicked (S778) and determines whether an EXIT button is clicked (S780). After skipping to the Reference Point A if the EXIT button is clicked, the method determines whether the BACKUP button on the AUTO UPGRADE screen is clicked if the EXIT button is not clicked (S782). The method performs the second backup process and saves contents of the third memory in the exchange file if the corresponding BACKUP button is clicked (S784). In addition, the method determines whether the RELOAD button on the AUTO UPGRADE screen is clicked if the BACKUP button on the AUTO UPGRADE screen is not clicked (S786). The method then performs the second RELOAD process and saves contents of the exchange file in the third memory if the corresponding RELOAD button is clicked (S788). Referring to FIG. 13, it is a schematic view illustrating an AUTO UPGRADE screen made according to a more preferred embodiment of the present invention.

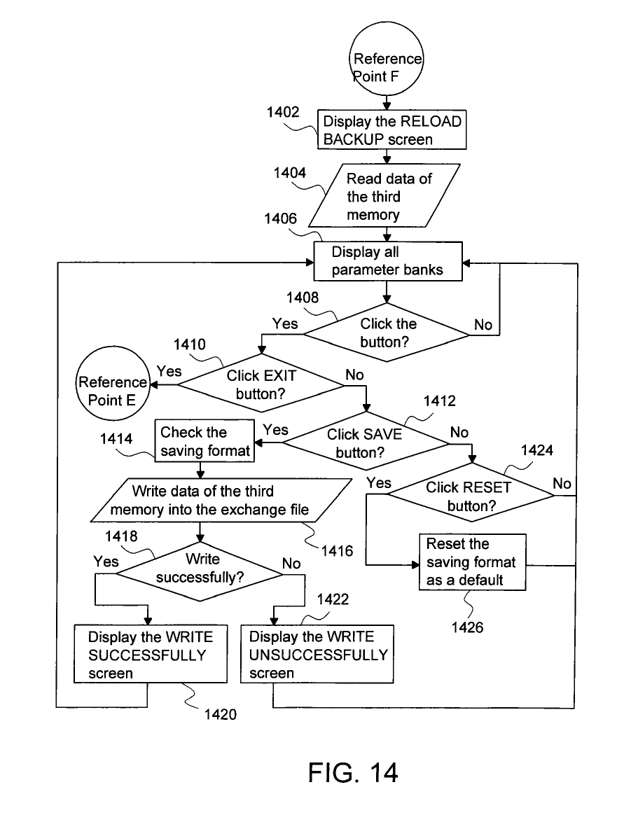

Referring to FIG. 14, it is a flowchart illustrating a first BACKUP process made according to a more preferred embodiment of the present invention. The first BACKUP process includes the steps of displaying a RELOAD BACKUP screen (S1402), reading the third memory (S1404), displaying all the parameter banks (S1406), determining whether a button is clicked (S1408), determining whether the EXIT button on the RELOAD BACKUP screen is clicked (S1410), skipping the Reference Point E if the corresponding EXIT button is clicked, determining whether the SAVE button on the RELOAD BACKUP screen is clicked if the corresponding EXIT button (S1412) is not clicked, checking the saving format if the corresponding SAVE button is clicked (S1414), writing contents of the third memory in the exchange file (S1416), determining whether the contents of the third memory are written successfully (S1418), displaying a WRITE SUCCESSFULLY screen (not indicated on the drawing) if the contents of the third memory are written successfully (S1420), and displaying a WRITE UNSUCCESSFULLY screen (not indicated on the drawing) if the contents of the third memory are written unsuccessfully (S1422). Continuing with S1412, the method determines whether the RESET button on the RELOAD BACKUP screen is clicked if the corresponding SAVE button is not clicked (S1424) and resets the saving format as a default format if the corresponding RESET button is clicked (S1426). Referring to FIG. 15, it is a schematic view illustrating a RELOAD BACKUP screen made according to a more preferred embodiment of the present invention.

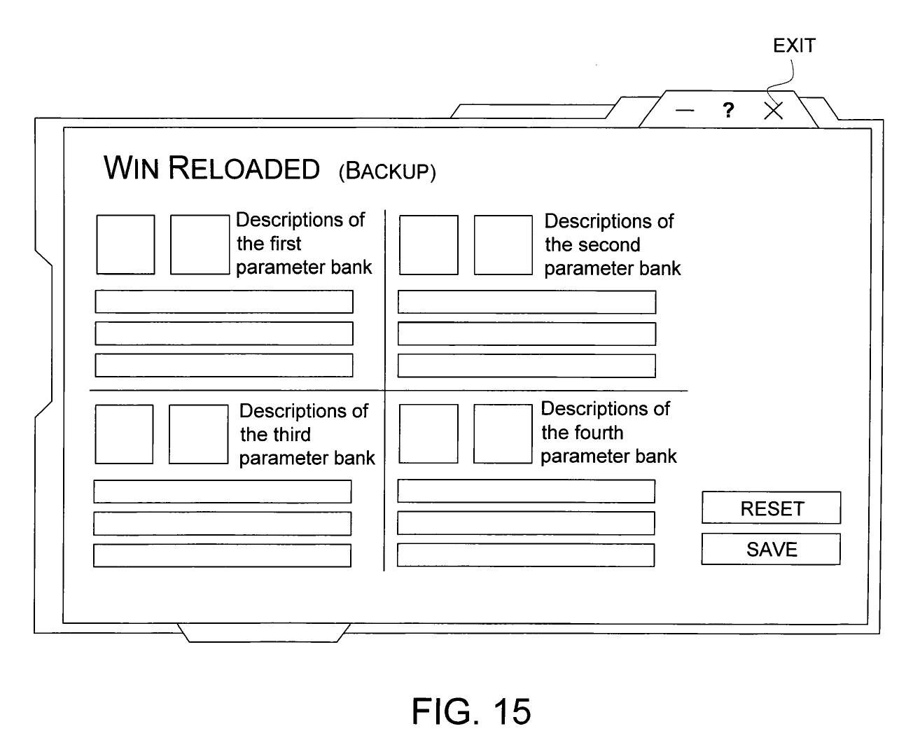

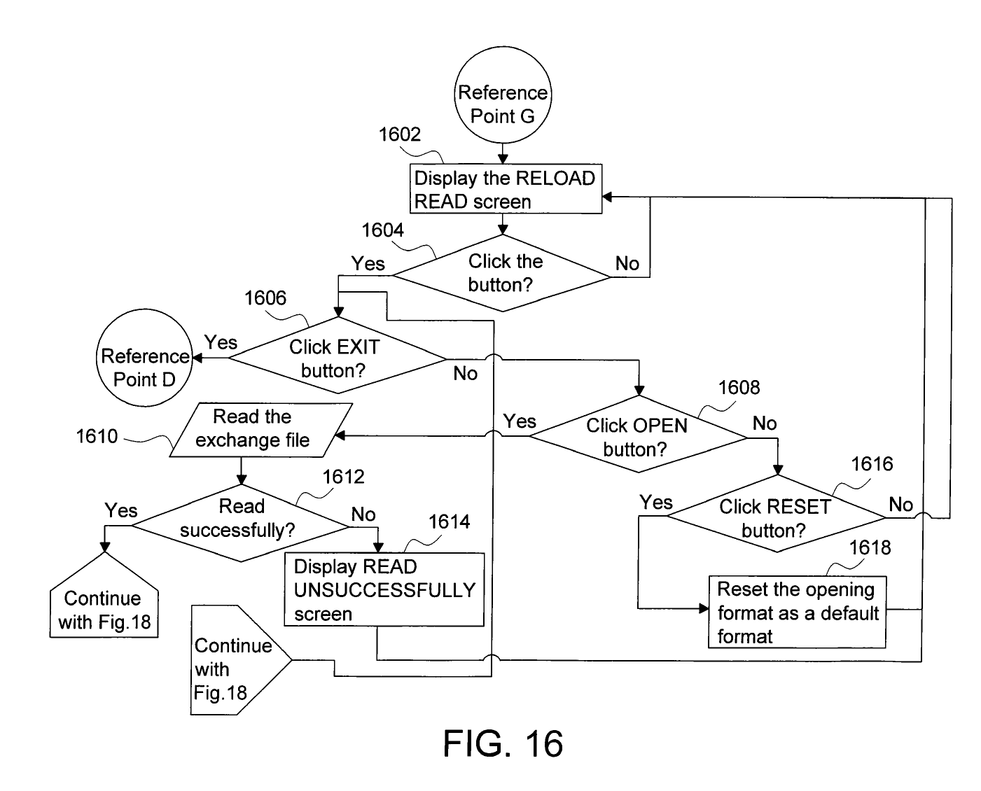

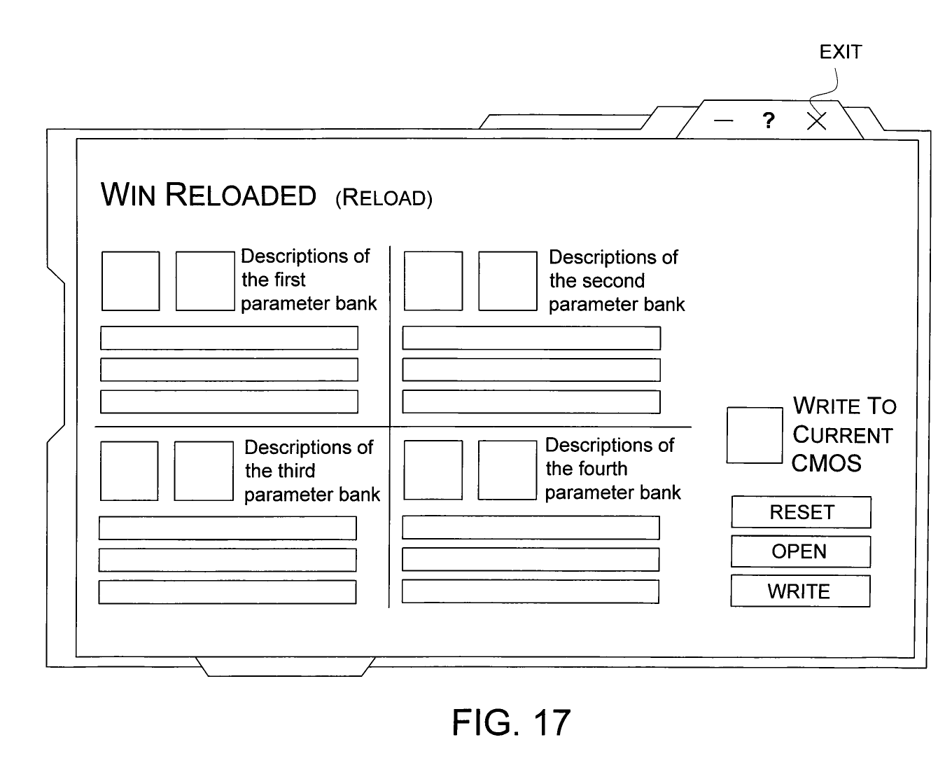

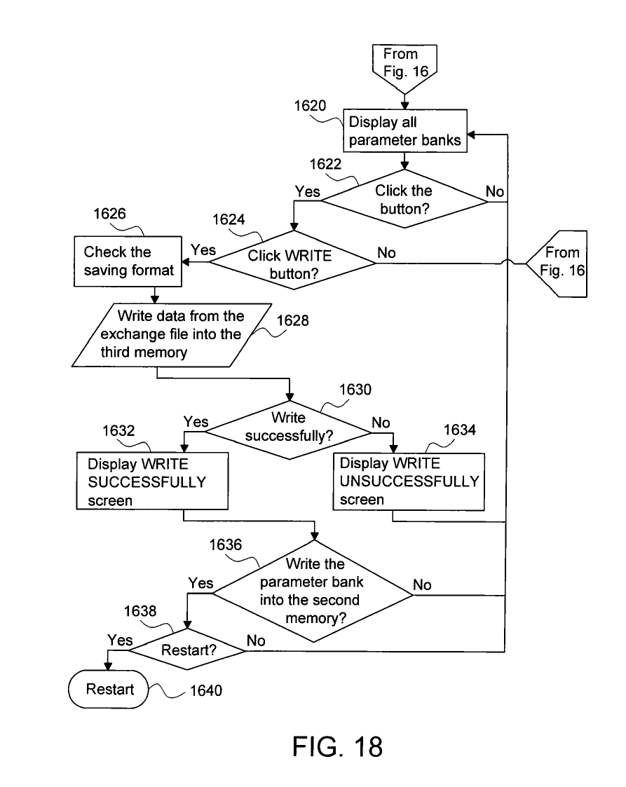

Referring to FIG. 16, it is a flowchart illustrating a first RELOAD process made according to a more preferred embodiment of the present invention. The first RELOAD process includes the steps of displaying a RELOAD READ screen (S1602), determining whether a button is clicked (S1604), determining whether the EXIT button on the RELOAD READ screen is clicked (S1606), determining whether the OPEN button on the RELOAD READ screen is clicked (S1608), reading an exchange file if the corresponding OPEN button is clicked (S1610), determining whether the exchange file is read successfully (S1612), and displaying a READ UNSUCCESSFULLY screen (not indicated on the drawing) if the exchange file is read unsuccessfully (S1614). Continuing with S1608, the method determines whether the RESET button on the RELOAD READ screen is clicked if the corresponding OPEN button is not clicked (S1616) and resets the opening format as a default opening format if the corresponding RESET button is clicked (S1618). Referring to FIG. 17, it is a schematic view illustrating a RELOAD READ screen made according to a more preferred embodiment of the present invention.

Referring to FIG. 18, continuing with S1612, the method displays all the parameter banks if read successfully (S1620). The method includes the steps of determining whether a button is clicked (S1622), determining whether a WRITE button on the RELOAD READ screen is clicked (S1624), checking the opening format if the corresponding WRITE button is clicked (S1626), writing contents of the exchange file into the third memory (S1628), determining whether the exchange file is written successfully into the third memory (S1630), displaying a WRITE SUCCESSFULLY screen (not indicated on the drawing) if the contents of the exchange file is written successfully (S1632), and displaying a WRITE UNSUCCESSFULLY screen (not indicated on the drawing) if the contents of the exchange file is written unsuccessfully (S1634). Continuing with S1632, the method includes the steps of determining whether the corresponding parameter bank is written into the second memory if the corresponding parameter bank is written successfully (S1636), determining whether the computer is restarted if the corresponding parameter bank is written into the second memory (S1638), and restarting the operating system if the computer is restarted (S1640).

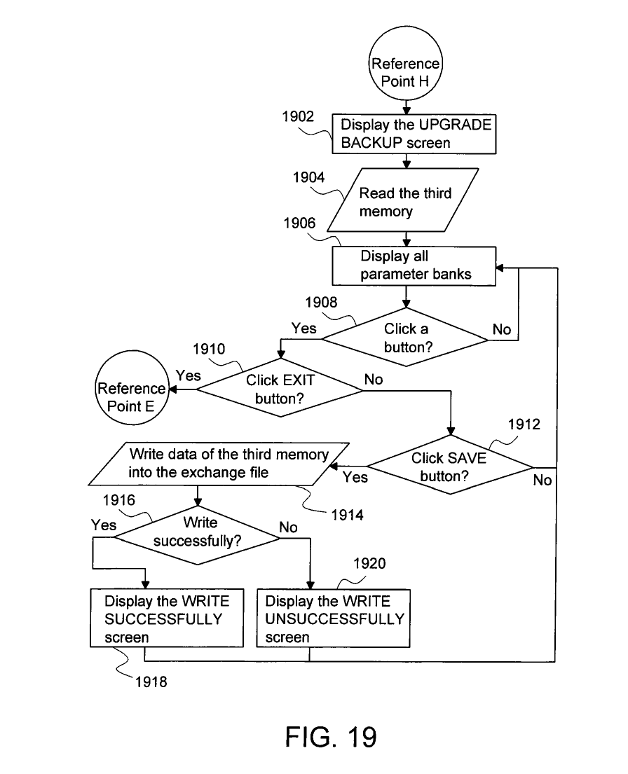

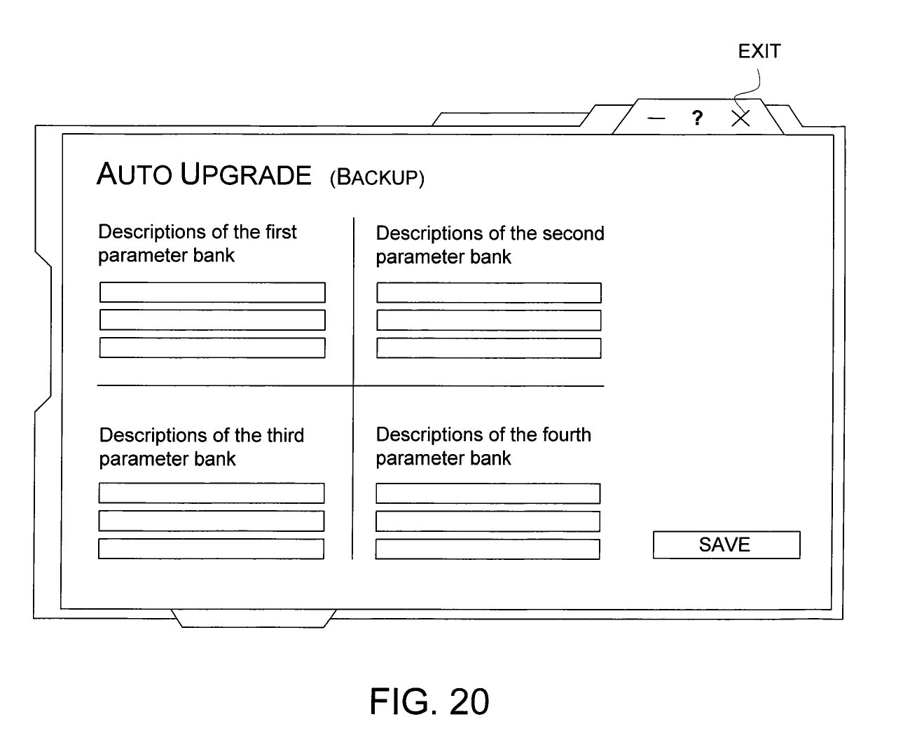

Referring to FIG. 19, it is a flowchart illustrating a second BACKUP process made according to a more preferred embodiment of the present invention. The second BACKUP process includes the steps of displaying an UPGRADE BACKUP screen (S1902), reading the third memory (S1904), displaying all the parameter banks (S1906), determining whether a button is clicked (S1908), determining whether the EXIT button on the RELOAD BACKUP screen is clicked (S1910), skipping to the Reference Point E if the corresponding EXIT button is clicked, determining whether the SAVE button on the RELOAD BACKUP screen is clicked if the corresponding EXIT button is not clicked (S1912), writing contents of the third memory in the exchange file if the corresponding SAVE button is clicked (S1914), determining whether the contents of the third memory are written successfully (S1916), and displaying a WRITE SUCCESSFULLY screen (not indicated on the screen) if the contents of the third memory are written successfully (S1918), and displaying a WRITE UNSUCCESSFULLY screen (not indicated on the screen) if the contents of the third memory are written unsuccessfully (S1920). Referring to FIG. 20, it is a schematic view illustrating an UPGRADE BACKUP screen made according to a more preferred embodiment of the present invention.

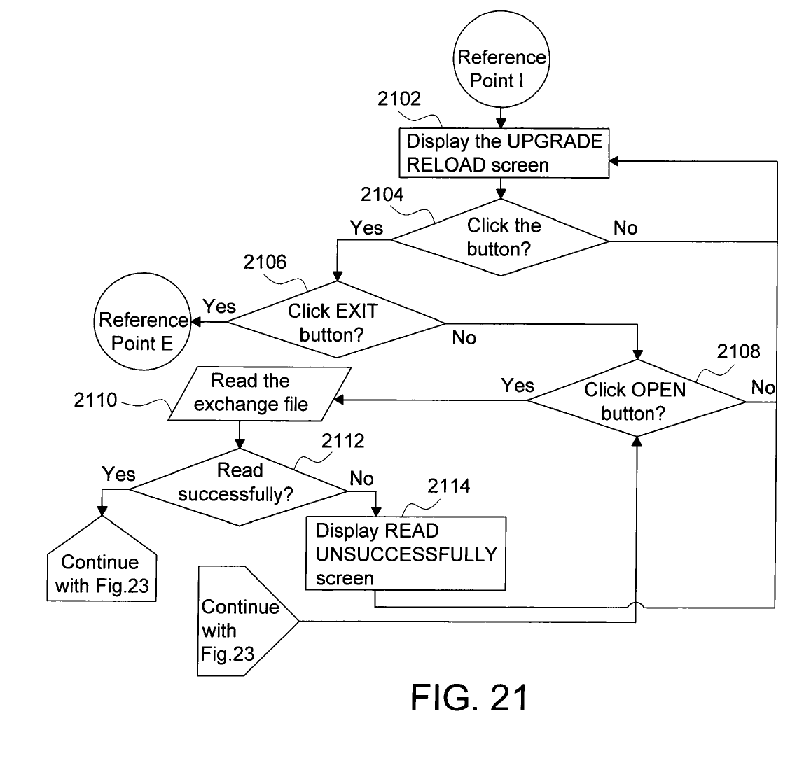

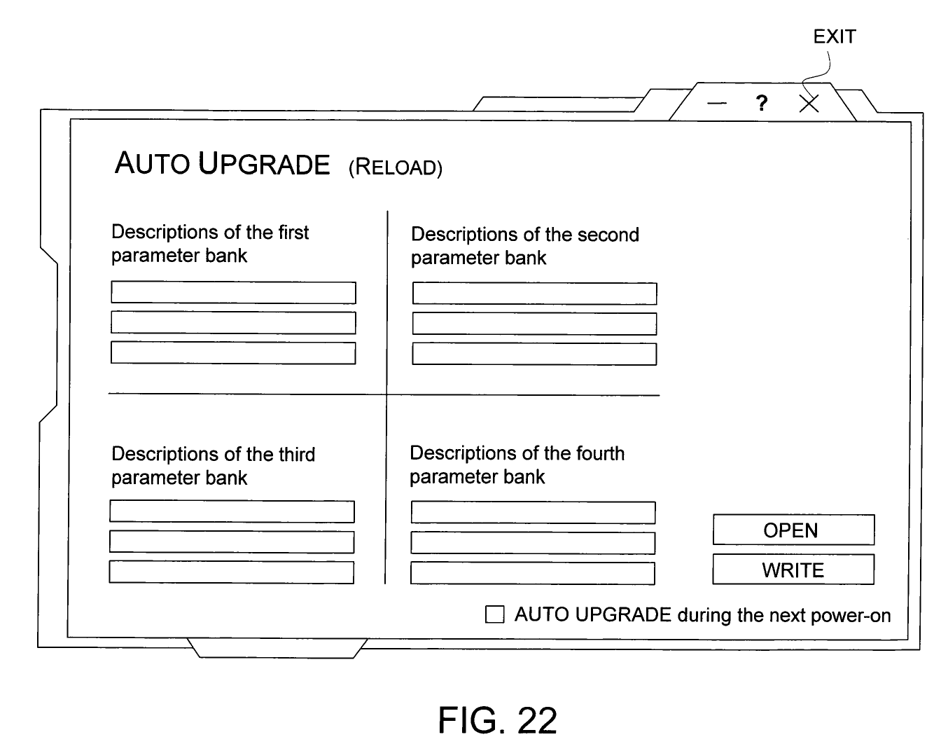

Referring to FIG. 21, it is a flowchart illustrating a second RELOAD process made according to a more preferred embodiment of the present invention. The second RELOAD process includes the steps of displaying an UPGRADE RELOAD screen (S2102), determining whether a button is clicked (S2104), determining whether the EXIT button on the UPGRADE RELOAD screen is clicked (S2106), determining whether the OPEN button on the UPGRADE RELOAD screen is clicked (S2108), reading the exchange file if the corresponding OPEN button is clicked (S2110), and determining whether the exchange file is read successfully (S2112), and displaying a READ UNSUCCESSFULLY screen (not indicated on the drawing) if the exchange file is read unsuccessfully (S2114). Referring to FIG. 22, it is a schematic view illustrating an UPGRADE RELOAD screen made according to a more preferred embodiment of the present invention.

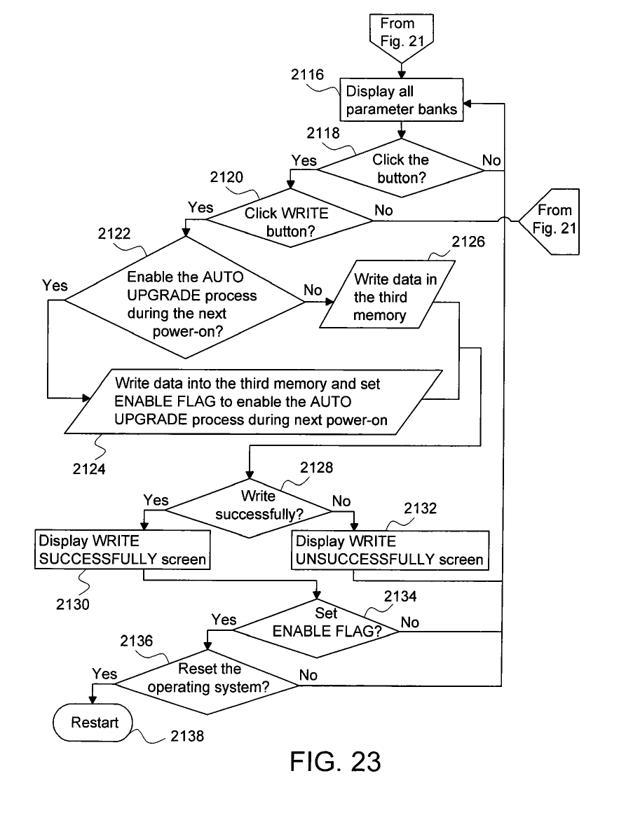

Referring to FIG. 23, continuing with S2112, the method includes the step of displaying all the parameter banks if the exchange file is read successfully (S2116). The method includes the steps of determining whether a button is clicked (S2118), determining whether the WRITE button on the UPGRADE RELOAD screen is clicked (S2120), determining whether the AUTO UPGRADE process is enabled during the next power-on if the corresponding WRITE button is clicked (S2122), writing corresponding data of the exchange file into the third memory and setting ENABLE FLAG if the user decides to enable the AUTO UPGRADE process during the next power-on (S2124), writing corresponding data of the exchange file into the third memory if the user decides not to enable the AUTO UPGRADE process during the next power-on (S2126), determining whether the corresponding data of the exchange file is written successfully into the third memory (S2128), displaying a WRITE SUCCESSFULLY screen (not indicated on the drawing) if the corresponding data of the exchange file is written successfully (S2130), and displaying a WRITE UNSUCCESSFULLY screen (not indicated on the screen) if the corresponding data of the exchange file is written unsuccessfully (S2132). Continuing with S2130, the method performs the steps of determining whether the ENABLE FLAG is set if the corresponding data of the exchange file is written successfully into the third memory (S2134), determining whether the operating system is restarted if the ENABLE FLAG is successfully set (S2136) and powering on the computer if the operating system is restarted (S2138). Referring to FIG. 22 again, the second RELOAD process sets the ENABLE FLAG if the “Automatically Upgrade during Next Power-on” is clicked.

Referring to FIG. 11 again, continuing with S758, when the user clicks on the RELOAD button, the selected parameter bank may not necessarily be overclocked successfully or other conditions may occur to the exchange file, for example, the exchange may be damaged or may not agree with the format. Consequently the first BACKUP process and the first RELOAD process are employed to process the conditions described above. In addition, if the technical service provider supplies the user with a tested parameter bank, the tested parameter bank is confirmed by this method to be correct and be capable of successful overclocking. Consequently, the second BACKUP process and the second RELOAD process are employed to process the conditions described above.

The invention being thus described, it will be obvious that the same may be varied in many ways for overclocking under any power-on status, such that a user can control the BIOS without using a conventional BIOS interface and the BIOS can automatically perform the corresponding action through the selected parameter bank. Such variations are not to be regarded as a departure from the spirit and scope of the invention, and all such modifications as would be obvious to one skilled in the art are intended to be included within the scope of the following claims.

What is claimed is:

1. A method for changing BIOS parameters via a hot key for use with an electronic apparatus comprising at least a first memory for saving a program of a BIOS, comprising the steps of:
saving at least a parameter bank in a third memory;
performing a keyboard-scanning process during power-on and determining whether at least a hot key is triggered;
selecting said parameter bank if said hot key is triggered; and
performing a corresponding BIOS action via said selected parameter bank.

2. The method for changing BIOS parameters via a hot key as claimed in claim 1, further comprising the steps of:
performing said keyboard-scanning process after said electronic apparatus is started and initiates a keyboard;
selecting one of said parameter banks and saving said selected parameter bank in a second memory if a plurality of parameter banks are saved; and
reading a corresponding BIOS parameter bank from said second memory during the next power-on in order to perform a corresponding action.

3. The method for changing BIOS parameters via a hot key as claimed in claim 1, wherein said electronic apparatus automatically selects said parameter bank if said hot key is triggered and said BIOS automatically boosts a clock of a microprocessor installed in said electronic apparatus via said parameter bank.

4. The method for changing BIOS parameters via a hot key as claimed in claim 1, further comprising the steps of
setting a HOT KEY FLAG as a first value;
determining whether said hot key is triggered;
setting said HOT KEY FLAG as a second value if said hot key is triggered;
and then setting a second FAIL FLAG as said first value;
setting said second FAIL FLAG as said first value if said hot key is not triggered;
determining if a testing process is performed;
setting a clock of a microprocessor if said testing process is not performed; and
determining if said HOT KEY FLAG is equal to said second value.

5. The method for changing BIOS parameters via a hot key as claimed in claim 1, further comprising the steps of:
determining whether a testing process is performed;
determining whether a first FAIL FLAG is equal to a second value if said testing process is performed;
setting a second FAIL FLAG as said second value if said first FAIL FLAG is equal to said second value;
setting a clock of a microprocessor as a default clock;
setting said first FAIL FLAG as a first value; and
determining if a HOT KEY FLAG is equal to said second value.

6. The method for changing BIOS parameters via a hot key as claimed in claim 1, further comprising the steps of:
determining if a testing process is performed;
determining whether a first FAIL FLAG is equal to a second value if said testing process is performed;
setting said first FAIL FLAG as said second value if said first FAIL FLAG is not equal to said second value;
enabling a watchdog process to detect a corresponding system;
setting a clock of a microprocessor;
detecting if said electronic apparatus is crashed;
restarting said electronic apparatus if said electronic apparatus is crashed;
setting said first FAIL FLAG as a first value if said electronic apparatus does not crash; and
determining whether a HOT KEY FLAG is equal to said second value.

7. The method for changing BIOS parameters via a hot key as claimed in claim 1, further comprising the steps of:
determining whether a HOT KEY FLAG is equal to a second value; and
determining whether an AUTO UPGRADE process is performed to automatically boost a clock of a microprocessor if said HOT KEY FLAG is equal to said second value.

8. The method for changing BIOS parameters via a hot key as claimed in claim 1, further comprising the step of performing an AUTO UPGRADE process, which comprises the steps of:
testing a CPU FSB clock; and
setting a corresponding parameter bank based on said CPU FSB clock such that said BIOS performs a corresponding action.

9. The method for changing BIOS parameters via a hot key as claimed in claim 8, further comprising the steps of:
detecting at least a DRAM speed;
generating a CPU/DRAM Ratio;
writing a corresponding parameter bank in a second memory; and
restarting said electronic apparatus.

10. The method for changing BIOS parameters via a hot key as claimed in claim 1, further comprising the step of displaying a message on a screen to indicate that a corresponding parameter bank is written in a second memory.

11. The method for changing BIOS parameters via a hot key as claimed in claim 1, further comprising the steps of:
determining whether a HOT KEY FLAG is equal to a second value;
determining whether a FAIL RELOAD process is performed if said HOT KEY FLAG is not equal to said second value;
if said HOT KEY FLAG is equal to said second value and an AUTO UPGRADE process is not performed, the method further comprises the steps of:
setting a second FAIL FLAG as said second value;
setting a single-mode parameter;
enabling a testing process;
setting a reload counter; and
determining whether said FAIL RELOAD process is performed.

12. The method for changing BIOS parameters via a hot key as claimed in claim 1, further comprising the steps of:
determining whether a FAIL RELOAD process is performed;
if said FAIL RELOAD process is performed, the method further comprising the steps of:
determining whether a second FAIL FLAG is equal to a second value;
determining whether a single-mode process is performed if said second FAIL FLAG is equal to said second value;
selecting said parameter bank and writing said parameter bank in a second memory if said single-mode process is performed; and
restarting said electronic apparatus.

13. The method for changing BIOS parameters via a hot key as claimed in claim 12, wherein if said FAIL RELOAD process is not performed or if said second FAIL FLAG is not equal to said second value, said method further comprising the steps of:
setting a reload counter as a fourth value;
determining whether said second FAIL FLAG is equal to said second value;
displaying a message “Failed” on a screen if said second FAIL FLAG is equal to said second value; and
ending said process if said second FAIL FLAG is not equal to said second value.

14. The method for changing BIOS parameters via a hot key as claimed in claim 12, wherein if said single-mode process is not performed, the method further comprises the steps of:
determining whether a reload counter is equal to a fourth value;
setting said reload counter as a third value if said count of said reload counter is equal to said fourth value;
writing a corresponding parameter bank in said second memory based on the content said reload counter; and
restarting said electronic apparatus.

15. The method for changing BIOS parameters via a hot key as claimed in claim 12, wherein if said single-mode process is not performed, the method further comprises the steps of:
determining whether a reload counter is equal to a fourth value;
subtracting 1 from said reload counter if said count of said reload counter is not equal to said fourth value;
writing a corresponding parameter bank in said second memory based on the contents of said reload counter; and
restarting said electronic apparatus.

16. The method for changing BIOS parameters via a hot key as claimed in claim 1, further comprising the step of forming an exchange file through said parameter bank, wherein said exchange file comprises said parameter bank and parameters in a second memory, and said exchange file is provided to a remote service provider for diagnosing said electronic apparatus.

17. The method for changing BIOS parameters via a hot key as claimed in claim 16, wherein a remote service provider and a near-end user can exchange said exchange file via the Internet such that said near-end user can change a corresponding BIOS parameter in a real-time manner.

18. The method for changing BIOS parameters via a hot key as claimed in claim 16, further comprising the step of performing an operating interface process, which further comprises the steps of:
forming, writing, reading, modifying and opening said exchange file;
selecting said parameter bank; and
performing a corresponding BIOS action based on said selected parameter bank during the next power-on.

19. The method for changing BIOS parameters via a hot key as claimed in claim 18, wherein said operating interface process further comprises the steps of:
writing said exchange file in said third memory;
saving contents of said third memory in said exchange file; and
modifying corresponding data of a second memory.

20. An apparatus for changing BIOS parameters via a hot key for use in computer systems, comprising:
a control unit;
a microprocessor, coupled to said control unit;
a first memory, coupled to said control unit;
a second memory, coupled to said control unit;
a third memory, coupled to said control unit, saving a plurality of parameter banks; and
a keyboard, coupled to said control unit;
wherein said first memory saves a program of a BIOS, and when said control unit performs a keyboard-scanning process during power-on, said control unit determines whether at least a hot key is triggered and if said hot key is triggered, one of said parameter banks is selected and said BIOS performs a corresponding operation based on said selected parameter bank.
